(19) United States
(12) Patent Application Publication
(10) Pub. No.: US 2015/0122117 A1
(43) Pub. Date: May 7, 2015

(54) Device And Method In Respect Of A Rock Drilling Machine And Rock Drilling Machine

(71) Applicant: Atlas Copco Rock Drills AB, Orebro (SE)

(72) Inventor: Per Jonsson, Orebro (SE)

(73) Assignee: Atlas Copco Rock Drills AB, Orebro (SE)

(21) Appl. No.: 14/401,876

(22) PCT Filed: May 30, 2013
(86) PCT No.: PCT/SE2013/050621

§ 371 Date: Nov. 18, 2014

(30) Foreign Application Priority Data
Jun. 28, 2012 (SE) 1250726-5

(51) Int. Cl. E21B 1/02; F15B 21/04; E21B 7/02; F16J 15/56

(52) U.S. Cl. CPC E21B 1/02; F16J 15/56; F15B 21/047; E21B 7/025
USPC 92/165 R; 92/261

(57) ABSTRACT

A device for a hydraulic rock drilling machine (1) for the protection of a piston seal unit (6) for sealing between a percussive piston (4) and a cylinder in a housing (2) of the rock drilling machine, wherein a piston guide (5) is positioned between the piston seal unit (6) and a working space in the cylinder. Between the piston guide (5) and the piston seal unit (6) there is arranged a surrounding ring-shaped inwardly open chamber (9), which is formed for receiving a hydraulic liquid volume. A hydraulic supply flow channel (12,13) for hydraulic liquid supply is connected to said chamber (9). The invention also concerns a rock drilling machine and a method.

### FIELD OF THE INVENTION

The invention relates to a device for a hydraulic rock drilling machine for the protection of a piston seal unit for sealing between a percussive piston and a cylinder in a housing of the rock drilling machine. The invention also concerns a rock drilling machine including such a device and a method.

### BACKGROUND OF THE INVENTION

In hydraulic rock drilling machines of the piston-cylinder type, during certain operational situations, wherein the percussive piston performs its movement to and fro, pressure pulsations occur being of such magnitude that cavitation occurs in the hydraulic fluid because of the high movement speed of the percussive piston in the working space of the cylinder.

In case cavitation bubbles in the hydraulic liquid reaches the piston seals, there is a risk that these are damaged when the bubbles collapse, which would results in leakage problems and shortened working life of the sealings.

In previously known hydraulic rock drilling machines, as a rule the region between the piston guide for the percussive piston and the pistons seals is connected to the draining system of the drilling machine. Hereby hydraulic liquid emerging between the piston guide and the piston is led away and a reduction of the hydraulic liquid pressure will be the result, which is intended to result in reduction of the loads on the sealings.

It has, however, been observed that this arrangement not entirely satisfactory reduces cavitation damages on the sealings.

From WO 2011/123028 A1 is previously known a rock drilling machine wherein it is provided an arrangement with an oil channel extending between a chamber in a percussive damping arrangement and a region adjacent to a seal. The oil channel includes a series of restrictions and oil volumes for preventing movements of cavitation bubbles through the oil channel. The document indicates that this arrangement can be used in respect of a percussive piston in a rock drilling machine.

### AIM AND MOST IMPORTANT FEATURES OF THE INVENTION

It is an aim of the present invention to provide a further development of previously known arrangements for protection of piston seals in hydraulic rock drilling machines and to at least reduce the problems that occurring cavitations cause on the piston seals.

This aim is achieved in a device as mentioned above in that between the piston guide and the piston seal unit there is arranged a surrounding ring-shaped inwardly open chamber, which is formed for receiving a hydraulic liquid volume, and that a hydraulic supply flow channel for hydraulic liquid supply is connected to said chamber.

By this way providing a fluid flow to the inwardly open chamber, said liquid flow preferably being in general continuous and/or constant, it is ensured in an effective way that pressure variations are cushioned and in a particular that the hydraulic liquid adjacent to the piston seal unit does not includes cavitation bubbles. Viz, through the liquid flow it is ensured that over time there is constantly an excess of hydraulic fluid wherein pressure variations can be levelled through the elasticity of the liquid and wherein it is avoided that cavitation bubbles are propagating because of insufficient access of unaffected hydraulic liquid in this region.

It is preferred that said hydraulic supply flow channel is arranged to start from a return flow channel from a hydraulic percussive damping arrangement in the rock drilling machine, since hereby is provided a hydraulic flow of suitable magnitude, a hydraulic flow that furthermore is already accessible in the rock drilling machine, and that also already has been used for its primary purpose. The use of this return flow therefore does not result in any reduced effect or further power take-out from the rock drilling machine. Alternatively, the source is an adjustable constant flow source, which does result in certain power consumption but gives greater possibilities of controlling the flow.

It is suitable and rational in respect of production that the piston seal unit is supported by a sealing holder wherein said chamber is received.

Suitably the piston seal unit provides two sealing devices which are arranged at an axial distance from each other.

Said chamber preferably adjoins to an auxiliary chamber over at least one connection channel, whereby an increase of the amount of accessible hydraulic liquid can be ensured. It is preferred that said hydraulic supply flow channel is arranged to connect to said chamber over the auxiliary chamber.

In an inventive hydraulic rock drilling machine, between said chamber and the piston guide there is preferably arranged a leakage draining exhaust. This leakage draining exhaust is suitably connected to a collecting tank over an intermediate space.

Between the chamber and the leakage draining exhaust there is advantageously arranged a slot towards the percussive piston, said slot having narrow slot width and short axial length in order to give as good an effect as possible.

In a preferred aspect of the invention, the hydraulic rock drilling machine includes a processor and regulating means for achieving regulation of said hydraulic liquid supply as a response to pressure variations sensed by a pressure sensor. Preferably the pressure sensor senses pressure variations in said chamber or, at occurrence, in said auxiliary chamber.

The invention also concerns a method for the protection of a piston seal unit for sealing between a percussive piston and a cylinder in a housing of a rock drilling machine, wherein a piston guide is positioned between the piston seal unit and a working space in the cylinder. Hydraulic liquid is supplied from a hydraulic liquid supply to a surrounding ring-shaped inwardly open chamber provided between the piston guide and the piston seal unit for receiving a hydraulic liquid volume.

Corresponding features and advantages as indicated above in respect of the device are also valid in respect of the inventive method.

When the hydraulic liquid supply is regulated as a response to sensed pressure variations, typically said hydraulic liquid supply is increased as a response to registering of increased pressure variations.

### BRIEF DESCRIPTION OF DRAWINGS

The invention will now be described in greater detail by way of embodiments and with reference to the annexed drawings, wherein:

FIG. 1 shows an inventive rock drilling machine in an axial partial section,

FIG. 2 shows, in a larger scale, a part of the representation in FIG. 1, and

FIG. 3 diagrammatically illustrates an inventive method.

### DESCRIPTION OF EMBODIMENTS

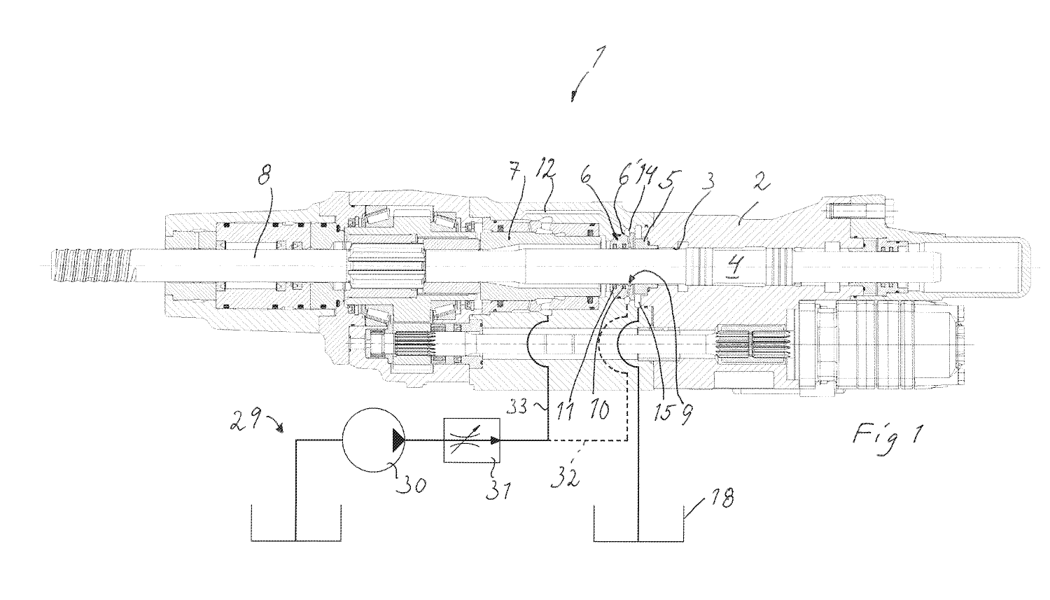

FIG. 1 shows in an axial section a hydraulic rock drilling machine 1, which in a housing 2 includes a percussive piston 4 which is moveable to and fro inside a cylinder 3. The percussive piston 4 is guided inside the housing 2 by a piston guide 5 in the form of a guiding sleeve. A piston seal unit 6 being arranged for preventing hydraulic liquid from extending into the lower part of the rock drilling machine is provided with two axially separated sealing devices in the form of piston seals 10 and 11.

In operation the percussive piston 4 performs percussive action against a shank adapter 8, which is received inside the rock drilling machine and against which in a per se known manner a damping piston 7 abuts for damping strike reflexes. The damping piston 7 has a damping flow circuit 29 for its supply.

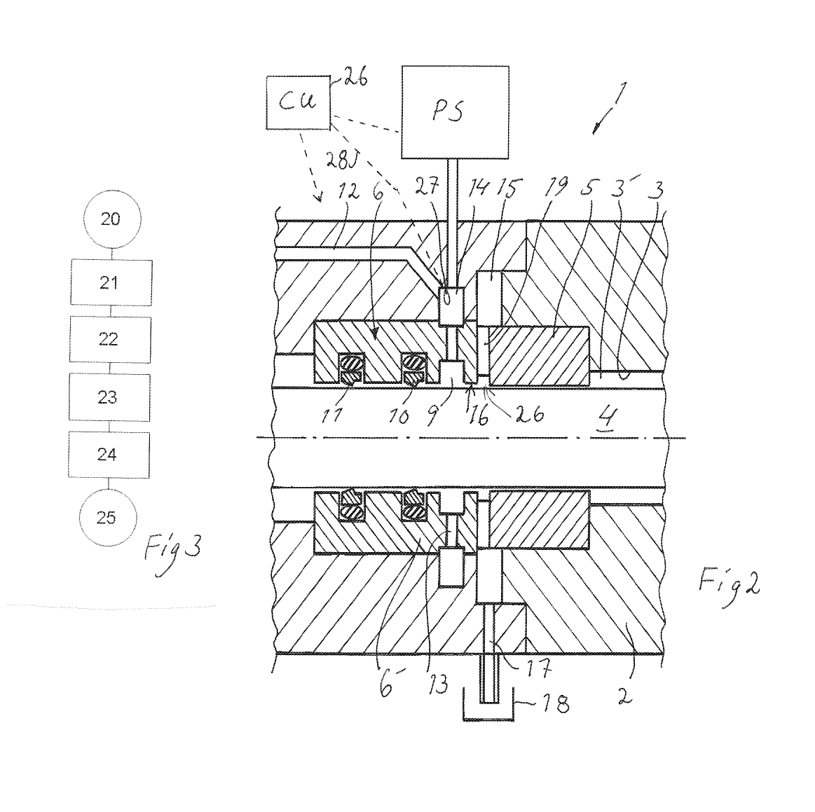

At the piston seal unit 6 is formed a ring-shaped chamber 9 which opens inwardly against the percussive piston 4 and which is situated between the piston seals 10, 11 and the piston guide 5. The ring-shaped chamber 9 is in the shown embodiment fed with an essentially continuous and suitably constant hydraulic fluid flow in the form of a return flow from the damping unit over a supply channel including a channel 12 and an auxiliary channel (-channels) 13 (see FIG. 2). This flow, through the channel 12, leads to the chamber 9 also over an auxiliary chamber 14 being situated at a short distance from the chamber 9. Through the auxiliary chamber 14 there is provided an extra hydraulic liquid volume close to the ring-shaped chamber 9 which is valuable in order to increase the effect of the invention.

A variant for providing a hydraulic liquid flow to the chamber 9 is illustrated through the damping flow circuit, globally indicated with 29, which includes a hydraulic pump 30 and a controllable restriction 31. Hydraulic liquid supplied through the circuit 29 is delivered to the damping arrangement through the conduit 33 and is thereupon led according to the above from the damping arrangement over the channel 12 to the chamber 9. Alternatively a flow can come from the hydraulic pump 30 and the restriction 31 (or any other hydraulic liquid source) directly to the chamber 9 which is indicated with the interrupted line 32.

FIG. 2 shows the arrangement at the piston seals more in detail, wherein it is apparent that between the piston guide 5 and the piston seals 10, 11, a leakage draining exhaust is arranged, globally indicated with 34. This leakage draining exhaust 34 most inwardly against the piston is provided with an inwardly open continuously extending surrounding groove, which over radially extending channels 19 communicates with a collecting space 15 which in turn over a channel 17 leads away collected hydraulic liquid to a collecting tank 18.

In operation of the device according to the invention, because of the movements of the percussive piston, during certain operational situations, great pressure variations will occur in the space 3′ between the percussive piston 4 and the wall of the cylinder 3. The space 3′ is hereby a working space inside the cylinder.

In case the pressure variations are sufficiently great, they will in turn lead to the formation of cavitation bubbles which tend to follow leaking hydraulic liquid and leak out through a slit being formed between the piston guide 5 and the percussive piston 4. In case of great amounts of cavitation bubbles in the liquid, in conventional rock drilling machines there is a risk that at least some of the bubbles find their way all the way to the piston seals 10, 11 so as to, during the collapse of the cavitation bubbles, cause damages on these piston seals.

Some of the cavitation bubbles are led away over the leakage draining exhaust 34, but it has been observed, as is indicated above, that this arrangement is not entirely satisfactory to eliminate the risk of damages to the sealings. A problem with the conventional arrangement has also been shown to occur when in the drilling machine the collecting space 15 is connected to other drainage exhausts from other components in the rock drilling machine. It has thus been observed that unwanted pressure variations with resulting cavitation bubbles in these other components can be transferred over the leakage draining exhaust 34 to the region between the piston guide 5 and the piston seals 10, 11 and damage the latter.

This insight is in all the background to the establishment of the ring-shaped chamber 9 being inwardly open against the piston between the piston guide 5 and the piston seal unit. This chamber 9 is formed for receiving a hydraulic liquid volume and a hydraulic supply flow channel 12, 13 is arranged for hydraulic liquid supply to this chamber 9. PS indicates an alternative hydraulic liquid source.

Preferably this hydraulic supply flow channel starts from the return flow channel from the damping arrangement in the rock drilling machine, according to the above. Hydraulic liquid being supplied to the chamber 9 is thereupon led over the slot 16 through the leakage draining exhaust 34 to tank.

14 indicates an auxiliary chamber which is ring-shaped and positioned radially outside the chamber 9. The chamber 9 communicates with the auxiliary chamber 14 over a number of radially extending auxiliary channels 13. The provision of the extra auxiliary chamber 14 results in a preferred increase of the hydraulic liquid volume in the region between the piston seals and the piston guide which is advantageous for the reduction of the effect of the pressure pulsations and thereby the cavitation damage risk.

The piston seal unit 6 is in the shown embodiment formed by a double seal with the piston seals 10 and 11 supported by a device forming a seal holder 6′, wherein also said ring-shaped chamber 9 is received.

The invention can be modified within the scope of the following claims. The piston seal unit 6 can thus include one or more piston seals. The width of the slot 16 between the chamber 9 and the leakage draining exhaust 34 is preferably held as small as possible and its axial extension as small as possible. It is preferred that the slot width is set to 0.5-1% of the piston diameter and the axial length of the slot to 1-10% of the piston diameter. The volume of the chamber 9 should preferably be as great as possible but it has been observed that a volume of 0.5-5.0 cm² gives very good effect in respect of a standard machine. The volume of the auxiliary chamber 14 should exceed and preferably be at least twice the volume of the chamber 9.

It is preferred that the hydraulic liquid supply flow is adjustable such that it can be adapted to the operation of the rock drilling machine and to the prevailing requirements. Hereby it should be observed that preferably the flow is essentially continuous and/or constant and is not allowed to fluctuate over for example a percussive cycle of the rock drilling machine. On the other hand it is an advantage to be able to regulate a magnitude of the flow as a response to sensed pressure variations in the chamber 9 or in the auxiliary chamber 14. Sensing the pressure variations in these situations can be achieved by way of per se known pressure sensors having small dimensions. In FIG. 2 is as an example shown a pressure sensor 27 positioned in the auxiliary chamber 14. The flow is typically regulated such that a sensed increase of the pressure variations leads to an increase of the hydraulic liquid flow to the chamber 9.

In FIG. 3 a method according to the invention is diagrammatically illustrated, wherein:

Position 20 indicates the start of a method sequence.
Position 21 indicates supply of hydraulic liquid from a hydraulic liquid source such as a return conduit from a damping unit in the drilling machine to the chamber 9.
Position 22 indicates sensing pressure variations in the chamber 9 or in the auxiliary chamber 14.
Position 23 indicates evaluating the signals from the pressure sensor 27 which are passed on over signal cable 28 to a processor 26.
Position 24 indicates regulating the hydraulic liquid flow to the chamber 9 as a response to the result of the evaluation in the processor 26.
Position 25 indicates the end of the sequence.

It should be understood that the method sequence is repeated to the extent that is suitable and required for good operation of the machine.

1. Device for a hydraulic rock drilling machine (1) for the protection of a piston seal unit (6) for sealing between a percussive piston (4) and a cylinder in a housing (2) of the rock drilling machine, wherein a piston guide (5) is
positioned between the piston seal unit (6) and a working space in the cylinder, wherein
between the piston guide (5) and the piston seal unit (6) there is arranged a surrounding ring-shaped inwardly open chamber (9), which is formed for receiving a hydraulic liquid volume, and
a hydraulic supply flow channel (12,13) for hydraulic liquid supply is connected to said chamber (9).

2. Device according to claim 1, wherein said hydraulic supply flow channel (12,13) is arranged to start from any one of the group: a return flow channel from a hydraulic percussive damping arrangement in the rock drilling machine, an adjustable constant flow source.

3. Device according to claim 1, wherein the piston seal unit (6) is supported by a seal holder (6′) in which said chamber is received.

4. Device according to claim 1, wherein the piston seal unit (6) provides two sealing devices (10,11) which are arranged at an axial distance from each other.

5. Device according to claim 1, wherein
said chamber (9) connects to an auxiliary chamber (14) over at least one auxiliary channel (13).

6. Device according to claim 5, wherein said hydraulic supply flow channel (12,13) is arranged to connect to said chamber over the auxiliary chamber.

7. Hydraulic rock drilling machine, wherein said hydraulic rock drilling machine includes a device according to claim 1.

8. Hydraulic rock drilling machine according to claim 7, wherein between said chamber (9) and the piston guide (5) a leakage draining exhaust (34) is arranged.

9. Hydraulic rock drilling machine according to claim 8, wherein the leakage draining exhaust (34) over a collecting space (15) is connected to a collecting tank (18).

10. Hydraulic rock drilling machine according to claim 8, wherein between the chamber (9) and the leakage draining exhaust (34) a slot (16) is arranged against the percussive piston.

11. Hydraulic rock drilling machine according to claim 7, wherein said hydraulic rock drilling machine includes a processor (26) for regulating said hydraulic liquid supply as a response to pressure variations sensed by a pressure sensor (27).

12. Method for the protection of a piston seal unit (6) for sealing between a percussive piston (4) and a cylinder in a housing (2) of a rock drilling machine, wherein a piston guide (5) is positioned between the piston seal unit (6) and a working space in the cylinder, wherein between the piston guide (5) and the piston seal unit (6) there is provided a surrounding ring-shaped inwardly open chamber (9) for receiving a hydraulic liquid volume, and hydraulic liquid is supplied to said chamber from a hydraulic liquid supply.

13. Method according to claim 12, wherein said hydraulic supply flow is passed to said chamber (9) over an auxiliary chamber (14).

14. Method according to claim 12,
wherein said hydraulic supply flow is arranged to start from any one of the group: a return flow channel from a hydraulic percussive damping arrangement in the rock drilling machine, an adjustable constant flow source.

15. Method according to claim 12, wherein said hydraulic liquid supply is regulated as a response to pressure variations in said chamber (9) or at occurrences in said auxiliary chamber (14).

16. Method according to claim 15, wherein said hydraulic liquid supply is increased as a response to increased pressure variations in said chamber or at occurrences in said auxiliary chamber.

17. Device according to claim 2, wherein the piston seal unit (6) is supported by a seal holder (6′) in which said chamber is received.

18. Hydraulic rock drilling machine according to claim 9, wherein between the chamber (9) and the leakage draining exhaust (34) a slot (16) is arranged against the percussive piston.

19. Method according to claim 13,
wherein said hydraulic supply flow is arranged to start from any one of the group: a return flow channel from a hydraulic percussive damping arrangement in the rock drilling machine, an adjustable constant flow source.

20. Method according to claim 13, wherein said hydraulic liquid supply is regulated as a response to pressure variations in said chamber (9) or at occurrences in said auxiliary chamber (14).
